(19) United States
(12) Patent Application Publication
(10) Pub. No.: US 2006/0041471 A1
(43) Pub. Date: Feb. 23, 2006

(54) Paperless purchase inducement merchant directory: merchandising method and means

(75) Inventors: Mark E. Szymusiak, Lancaster, NY (US); James A. Kolber, Clarence, NY (US); Aaron Kiefer, Amherst, NY (US)

Correspondence Address: PATRICIA M. COSTANZO, PATENT COPYRIGHT TRADEMARK LAW, 2960 BOWEN ROAD, ELMA, NY, 14059, US

(73) Assignee: Value Pages USA Inc., Amherst, NY (US)

(21) Appl. No.: 10/922,695

(22) Filed: Aug. 20, 2004

(51) Int. Cl. G06Q 30/00

(52) U.S. Cl. 705/14

(57) ABSTRACT

A merchant directory presenting paperless purchase incentives to consumers, comprising: a) merchant contact information, and b) Value Codes representing purchase incentives redeemable at product purchase. Value Codes may include particulars regarding each incentive. Directories may be distributed as printed matter or as an electronic directory and may include free gift offers to promote consumer loyalty to the directory. The directory includes a system, such as preaddressed, stamped postcards, for consumers to supply consumer contact information to merchants so that merchants may contact consumers predisposed to purchase merchant's products. The postcards may also include Value Codes as an inducement to consumer to provide merchant with consumer contact information. Directory listings may be limited to a maximum number of advertisers and may be arranged by seniority. The purchase incentives may be discount offers, two-for-one offers, buy one get one free, rebates, bank checks, a combination thereof, a free service, or the like.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates generally to a merchandizing method that creates transactional relationships between mutually benefiting transactors by providing means for a merchandiser of almost any product to secure a consumer's predisposed interest in purchasing particular products by providing a financial incentive in addition to a convenience incentive to do so. More particularly, this invention relates to merchandising methods and means for carrying out the methods including a novel method of presenting merchandiser locater listings that present paperless coupon incentives.

The background information discussed below is presented to better illustrate the novelty and usefulness of the present invention. This background information is not admitted prior art. The particular embodiments described below are provided, in part, as illustrative and exemplary. Thus, the described embodiments should not be taken as limiting. Additionally, the invention is not limited to the examples provided.

Once a consumer decides to make a purchase, the consumer must identify, and locate, a merchant from whom the purchase will be made. Usually, several merchants offer the desired goods or services and the consumer must decide which merchant to patronize. Marketers attempt to devise means to persuade consumers to patronize one merchant over others. Although consumers consider many factors when making such purchasing decisions, one of the most important decision-making factors is cost-savings and often the merchant who offers the largest discount will often be the one patronized by the purchaser. A successful marketing method will recognize the desire of consumers to make an economical purchase.

While planning a purchase, the use of cost-saving or specific incentive paper coupons are often available to a consumer. In fact, the use of specific incentive coupons is extremely popular with many shoppers as their use can dramatically reduce the cost of any particular purchase which can result in hundreds, if not thousands, of dollars saved per year. Incentive coupons are not limited to reduction-of-cost offers and may include free gifts of almost any kind of goods or services, such as a free bouquet or a free introductory dancing lesson. Studies show that ninety percent of the purchasing public use coupons for purchases ranging from food items to automobile tires.

Merchants are aware of consumers' wide use of incentive coupons and rely heavily on their use to attract consumers to products or services that are being marketed, to revive lagging sales, to reduce excess inventory, and to gain new customers. Retailers and service providers have also long relied on the use of discount coupons to market their products and to attract consumers to their particular shops. A successful marketing method will provide cost incentives to consumers.

While cost-saving coupons may result in significant savings for consumers, they require a significant amount of time to collect and manage. The coupons must first be clipped, if the paper coupon was offered in printed material, such as in newspapers and magazines. Once clipped or collected, paper coupons must then be sorted, expired coupons identified and discarded, and current coupons organized according to planned shopping. Large collections of paper coupons, however, are often bulky to carry. To assist in coupon management, many consumers rely on a special coupon holder, (i.e., a box or pocket folder) that, by itself, may be relatively large and heavy. Thus, the large number of coupons that a consumer carries to a store may result in not being able to find the coupon among all the others, resulting in a missed sale for the merchandiser and/or missed savings for the consumer. Moreover, coupons are easy to lose and/or damage, and in these cases consumers may decide that using coupons is simply too cumbersome and takes too much time and effort. Moreover, the use of coupons often results in frustration when coupons for desired products are not available at the time the purchase is contemplated. Similarly, if a consumer forgets to bring the coupons to the store, the coupons cannot be redeemed, and if a purchase is made, the frustrated consumer has to be content with his or her missed opportunity for consumer savings. Some consumers end up not using coupon offers because of all these disadvantages. Likewise, the merchandiser faces a missed opportunity in such a situation as the consumer decides not to make the purchase.

The use of paper redemption coupons poses problems for merchandisers, as well as for consumers. One of the largest problems associated with the use of coupons is their cost. Each coupon must be designed, printed, identified with the standard uniform product code (UPC), i.e., bar codes, that is now applied to nearly all products, and then distributed. The cost of coupons continues even after they are redeemed. First they must be collected by merchants at the time of redemption. Credit must then be provided to the customer purchasing the corresponding product. The coupons must be sorted and bundled to be forwarded to a clearing house and then to a redemption center for more sorting and counting. Reports must then be forwarded to the manufacturers issuing the coupons in order for the merchants to be granted the credit due to them for redeeming the coupons. A method and means of presenting purchase incentives that is more time and cost efficient and is more targeted than is the use of coupons would be of great benefit to both merchandisers and consumers.

Purchase incentives need not be limited to paper coupons. Merchants can advertise their purchase incentive offers in other ways, such as through advertisements in newspapers, radio and television commercials, infomercials, and other electronic types of advertising. These methods of marketing, however, are often extremely expensive and reach consumers randomly. In fact, all of these types of advertising are often too expensive for small businesses. A method and means of presenting purchase incentives that are more affordable and targeted than are advertisements in newspapers, radio and television commercials, infomercials, and other electronic types of advertising would be of great benefit to both merchandisers and consumers.

A common problem associated with the use of paper coupons is that either a consumer or a merchant, or both, will mistakenly identify one manufacturer's coupon for another's. Honestly mistaken, or deliberately miss-identified, the rate of redemption of incorrectly identified coupons can be as high as 20 to 30 percent. This problem is exacerbated by the large amount of time required to reimburse the retail stores for the discount given the consumer. Despite the seeming popularity of coupons, and even though the coupon industry expends great effort and expense in market research, printing, issuing, distributing, and redeeming coupons, the redemption rate of paper coupon is still relatively low. The low redemption rate of coupons has been attributed to the haphazard systems used by most consumers when manually clipping, filing, sorting through, and ultimately using the coupons as discussed above. Nevertheless, even though the use of coupons presents inconveniences for consumers and a lower rate of redemptions than wished for by merchandisers, their popularity and the extremely competitive nature of the market place prompts merchandisers to maintain the practice of offering coupons to consumers for their use. A successful marketing scheme will offer cost incentive schemes, but will find ways to alleviate the problems presented by the use of paper redemption coupons.

As briefly mentioned above, coupons, rebate offers, or bank checks are often provided to consumers in the form of advertising inserts in newspapers, magazine, or general mailings, which account for over 80 percent of coupons used. These costly advertising inserts and the related coupons are routinely mailed to large, untargeted, or poorly targeted sets of the population and usually make up the largest part of a merchandiser's advertising budget. Coupons delivered by mail are cost effective, however, only if used by a sufficiently high percentage of consumers. The redemption rate of coupons delivered by mail, however, has recently been shown to be approximately 2.8 percent and declining. Thus, it can be concluded that insert coupons are not very cost effective.

High advertising costs could be more easily justified if the coupons included with the inserts were able to reach targeted audiences, that is, an audience that is predisposed to accept the message sent by a merchandiser, such as a consumer who has already decided to purchase the specific item represented by cost inventive offer. Identifying predisposed groups of consumers routinely proves problematic. Data collection is often fraught with problems, especially with the problem of the invasion of the privacy of consumers. More cost effective ways of reaching targeted audiences and/or individuals are sorely needed.

A relatively new form of merchandising is able to tailor the coupons given to a consumer to the characteristics of that consumer. One way this is done is to match consumers with their purchases through the use of “shopper's cards.” Large retailers install systems based upon electronically programmed cards. The customers are induced to use the shopper“s cards by the cost benefits provided to those who partake in this system and to the seeming cost-detriment of those who do not. Consumers are also persuaded to use the cards when merchants require their use as a pre-condition to check cashing rights and/or to debit purchases against consumer's debit accounts. The electronic customer-card is passed through a special code reading device at the point-of-sale terminal in order to capture a personal identification number (PIN). The point-of-sale terminal also includes a laser scanner, or similar device, which identifies UPC bar codes on products in order to enter purchases into the in-store system. Purchases are matched to the customer through the PIN number. Because the file of the customer identified with the PIN code contains information regarding the income, demographic data, and the like, for that customer, an impressive data base may be established relating consumer characteristics to purchasing habits and thus to the offer of coupons that meet a shoppers shopping profile.

There are many problems, however, associated with the use of customer-card based systems. One major problem is that the system is intrusive of the consumers' privacy expectations and tends to collect more data than is necessary to target merchandising to that customer. Furthermore, the large amount of data collected makes it difficult for merchandisers to identify the buying habits of the card users and, even if such information may be obtained, there is no efficient mechanism for converting this information into enhanced sales. Furthermore, it is believed that such systems could discriminate against some purchasing groups, because the electronic customer-cards are sometimes given only to credit-worthy customers. The use of less intrusive and more discriminating marketing methods is clearly warranted. Thus, what is sorely needed is the means to reach specific consumers with incentive offers, such as rebates, two for one offers, bank checks, and the accumulation of activity points without compromising the privacy or the integrity of the consumer.

Furthermore, the cost of the routine use of electronic customer-card systems limits their use to only large scale merchandisers. Family owned, or otherwise small to mid-sized businesses, though arguably more in need of good marketing efforts than are large scale merchandisers, cannot afford to incorporate these expensive methods into their business plans. Clearly, less costly means are needed by both large and small merchandisers.

Finding ways to identify particular preferences of large numbers of people when using general advertising in addition to the use of mass mailings is extremely important to merchants. Advertising messages received by predisposed consumers are highly effective and help to reduce the overall cost of advertising, in addition to reducing the consumer's cost. Accordingly, cost effective direct marketing alternatives are being sought to replace the largely cost-ineffective marketing techniques that are currently being used.

Thus, it is clear that what is sorely lacking in the art is a way to create transactional relationships between mutually benefiting transactors (such as consumers and merchants) that will not present the problems inherent in the methods now used to attempt to establish transactional relationships. Accordingly, it would be a significant improvement in the art to provide mutually benefiting means to make contact with, and to capture the attention of, targeted members of the consuming public for the benefit of merchants wishing to sell products and for the benefit of consumers wishing to purchase those products. The invention described herein provides methods and means to create desired, mutually beneficial, transactional relationships.

### SUMMARY

This invention satisfies the pressing need to create mutually benefiting transactional relationships between consumers and merchandisers by providing merchandisers with a straightforward and low cost method of capturing the attention of predisposed consumers. The method, as described herein, allows merchandisers to identify and contact consumers, ie., consumers who are predisposed to being contacted and who are predisposed to purchasing merchandiser's products of interest, in order to present the predisposed consumer with selected cost incentives and information of relevance related to the product whose purchase is being contemplated. Additionally, the present invention provides the means for merchandisers to contact consumers predisposed to purchasing the goods or services of the merchandiser without the need for costly marketing studies or the use of invasive and discriminatory “shopper's cards”. Conceptually, the invention simply allows a merchandiser to obtain and hold the attention of a consumer who is predisposed to dealing with said merchandiser by offering consumer a cost incentive (that is not in the form of a paper coupon) toward the purchase at the time that is just prior to the making of the purchase.

Favored embodiments of the invention comprise directory booklets that lists merchants, their location, and contact information, including telephone numbers, e-mail addresses, web page addresses, and pertinent copy points, i.e., those criteria that are specific to individual businesses, in addition to presenting consumers paperless cost-savings incentives. One of these embodiments lists only local merchants, while another embodiment provides a regional or national listing. Yet another embodiment provides for listings of merchants located abroad, which is especially useful when planning a trip, such as a vacation or business trip. Another favored embodiment is an electronic version of the directory, i.e., an e-directory, which may be accessed through interactive closed-circuit or Internet-type connections. In all embodiments, a unique aspect of the present invention is that all cost-savings incentives are offered to the consumer in the form of a “Value Code” that is included in the directory as part of each merchant's entry. A Value Code is used in place of a paper coupon. The Value Code is an easy to remember code that may be a number, a word or set of words, an alphanumeric string, or a symbol. Value Codes represent, and result in obtaining, the same type of purchase incentives as are offered by typical paper redemption coupons, without the problems associated with the use of paper coupons. As each page of the directory lists several merchants and each merchant has a unique associated Value Code, the directory may be referred to as a Value Pages Directory.

When a consumer is interested in making a purchase, the consumer simply consults a Value Pages Directory, which is delivered to each consumer's home and/or is available electronically, to locate a merchant who offers the product desired by the consumer and who is conveniently accessible. Before making a trip to the merchant's place of business, which may be either or both virtual or actual, the consumer makes a memory note or written note of the merchant's Value Code. Each merchant's Value Code may be accompanied by particulars of a merchant's purchase incentive or simply listed without any redemption particulars. If the Value Code is presented without any particulars regarding a cost-savings incentive, the consumer may call or visit, actually or virtually, the merchant to find out what purchase incentives are being offered in conjunction with the Value Code. At the time of purchase, the consumer mentions the merchant's Value Code to the merchant to “redeem” whatever purchase value is represented by the merchant's Value Code.

Value Codes are able to represent any financial, or other, incentive offered by a merchandiser. Some of the incentives that are considered standard in the industry include: Buy One—Get One Free; 5% OFF any purchase; 10% OFF any purchase; 25% OFF any purchase; 1$ OFF any purchase; $10 OFF any purchase; $50 OFF any purchase; $100 OFF any purchase; Free Gift for every new customer; and Free Trial, for example.

The Value Pages Directory, thus, allows consumers who are predisposed to making a purchase to identify a merchant, locate his place of business, and to be presented with a discount Value Code, easily and quickly. That is, at the very moment the consumer is interested in, and thus, predisposed to making a given purchase, the consumer is presented with one or more Value Codes that each represent an inducement for the consumer to purchase from the merchant(s) offering the inducement(s). Moreover, the consumer obtains the relevant Value Code without any of the inconvenience associated with hunting for, cutting out, storing, and remembering to bring to the store a paper discount coupon.

Correspondingly, the Value Pages Directory allows merchandisers to present their purchasing incentives directly to consumers who are predisposed to interacting with that merchant without the need for paper coupons and for all of the work and cost that goes into providing consumers with typical paper coupons. Moreover, as the cost of participating in a Value Pages Directory is much less than using typically advertising, as described above, both large and small businesses can take advantage of the advantages gained using Value Codes. In one embodiment, Value Pages Directories are mailed directly to a large segment of homes and businesses that are located in geographical areas of interest to merchandisers listed in the Directory. Thus, the Value Pages Directory is a potent and cost-effective way to associate consumers with local merchants and with the merchant's purchase inducements in an extraordinarily efficient and effective way. The invention provides for the Value Pages Directory to provide this connection between merchandiser and predisposed consumer to be present in consumer's home all day, every day, and, most importantly, at the exact time the consumer is ready to make a purchase. This “always at hand” connection between merchant and consumers makes the present invention a more effective alternative to other forms of advertising, such as advertising in the yellow pages, newspapers, direct mail paper coupons, television and radio, which, as is well known, are extremely expensive ways for merchandisers to reach consumers.

In one embodiment, to ensure that the Value Pages Directory is appreciated and routinely consulted by consumers, the Value Pages Directory may contain generalized inducements, such as offers for free gifts when the consumer participates in some behavior desirable to a merchant. Such a behavior may be a consumer's visit to a merchant's place of business. Thus, a generalized inducement would, for example, offer consumer one free dough-nut a month for a visit made to the merchants bakery. To protect merchants from having this incentive abused, the Value Pages Directory may present means for merchants to record the giving of each free gift. For example, along with the merchant's general inducement offer the Directory provides a monthly calender, where each month is marked by the merchant at the time the gift was accepted by a consumer.

If consumers are interested in being contacted in the future by particular merchandisers, the Value Pages Directory offers stamped, tear-out postcards, pre-addressed to a merchant. The postcards provide a place for consumers to place their contact information and a place for the consumer to indicate in which manner they would like to be contacted, such as by telephone, mail, or e-mail. Merchants may choose to offer a Value Code on these postcard that is redeemable when certain conditions are met, such as if the consumer brings the postcard to the merchant's place of business, for example. This method of merchandizing provides a means for merchants to identify the consumers who are predisposed to the merchant's products.

Besides effectively bringing together merchants and consumers at the right time, i.e., at the time the consumer wishes to make a purchase, the Value Pages Directory is extremely cost effective for merchants. As Value Codes eliminate the need for dependence on paper coupons, merchandisers no longer have the high costs related to the design of the coupon, its printing and concomitant association with a product's UPC bar, and the subsequent distribution of the coupons. Additionally, the use of Value Codes eliminates the need for merchants to collect coupons at the time of redemption, to sort coupons at the end of the day, and to bundle coupons for transport to a clearing house. Another problem that is inherent with the use of paper coupons, but is eliminated with the use of Value Codes, is incorrect coupon redemption as a merchant’s value code is unique to one merchant and would not be recognized by another merchant.

Another embodiment of the present invention limits the numbers of merchants in each category, thus limiting the total number of merchants and value incentives offered in the Value Pages Directory. This feature provides consumers with fewer confusing choices. Yet another unique feature of the Directory is that all listings are relatively comparable in presentation, differing only in such ways as, different color, bold versus regular type, and outlining of a listing, thus allowing for greater equality among listings regardless if the listings represent national corporate interests or the local small businessperson. Consequently, the present invention provides a unique method of attracting new business, as well as encouraging growth in sales volume, in addition to building a loyal consumer base. In short the invention, “Value Pages,” provides the method and the means to combine affordable Directory advertising with paperless cost incentive coupon offers.

The invention as described herein solves the above-described and other problems in the art by providing for a means, which may be a merchant directory, for a merchant to present paperless purchase incentives to at least one consumer, the means comprising:

a) contact information relating to at least one merchant, and

b) at least one Value Code, wherein Value Codes represent at least one incentive for the purchase of the merchant's products, wherein the value incentives are redeemable at product purchase.

The invention further includes a process by which the means, which may be a merchant directory, may be made available to the at least one consumer. The means may be printed matter or may comprise electronic means which may be part of an interactive Internet site.

The means, which may be a merchant directory, may further include at least one free gift offer to induce consumer loyalty to using the directory means. The means may further include a system for merchants to contact consumers predisposed to purchase the merchant's products, wherein such a system may comprise stamped, self-addressed postcards wherein consumer contact information may be provided to the merchant. Such postcards may also present Value Codes to consumers as an inducement for consumers to share their contact information with merchants using such a system.

Moreover, the invention describes a method for creating objective transactional relationships between reciprocally mutually benefiting transactors, wherein transactors are at least one merchandiser and at least one consumer, the method comprising the steps of:

a) providing for at least one Value Code wherein the at least one Value Code represents at least one product purchase incentive offered by at least one merchant to at least one consumer;

b) providing a means for distributing the at least one Value Code to the at least one consumer, and

c) distributing the at least one Value Code to the at least one consumer using the means for distributing, wherein the product purchase incentive is redeemed at product purchase.

The method further comprises wherein each of Value Code may comprise an alpha code, a numeric code, an alphanumeric code, or a code of other types of symbols, as desired by a merchant. Product purchase incentives may comprise discount offers, two-for-one offers; buy one get one free, rebates, bank checks, a free service, a combination thereof, or the like.

The method further comprises wherein the means for distributing Value Codes to consumers is a directory that may be printed material and/or may comprise an electronic directory, wherein the electronic directory is available to the consumers via an interactive computer system that may be part of an Internet system such as the World Wide Web.

The method directory listings that may be arranged by seniority of the listing parties so as to give all parties, including small and new businesses the same directory presentation. Similarly, the listings may be limited to a maximum number of advertisers to reduce confusion for consumers.

In summary, the invention may be described as paperless purchase incentive merchant directory in which at least one merchant presents at least one paperless purchase incentive to at least one consumer, wherein the directory comprises:

a) contact information relating to the at least one merchant, and

b) at least one Value Code representing at least one purchase incentive, wherein the purchase incentive is redeemable at time of product purchase, and

wherein the directory may comprise printed matter or be an electronic directory on a computer network such as the Internet.

Thus, the invention as described provides the method and the means for a merchandiser to offer, actually and virtually, purchase cost incentives to a receptive audience that is predisposed to purchasing merchant's goods or services while significantly reducing the merchant's marketing costs. The invention also provides a method and means for a predisposed consumer audience to locate merchants who offer the products that are of immediate interest to the consumer and to simultaneously identify purchase cost incentives on those products, thus presenting consumers with cost savings at the exact time of the purchase.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention, may be more fully comprehended, the invention will now be described, by way of example, with reference to the accompanying drawings, wherein like reference characters indicate like parts throughout the several figures, and in which:

FIG. 1 is a step-chart diagram illustrating basic procedural steps of the paperless purchase incentive/Value Code marketing method in accordance with the teachings of this invention.

FIG. 2 is a step-chart diagram illustrating more exemplary procedural steps of the paperless coupon/Value Code advertising method, as shown in FIG. 1.

FIG. 3 is a step-chart diagram illustrating more exemplary procedural steps of the paperless coupon/Value Code advertising method, as shown in FIGS. 1 and 2.

FIG. 4 illustrates an example of a cover page of a Value Page Directory containing Value Codes as illustrated in FIG. 4a.

FIG. 4a illustrates exemplary Value Codes and Value Incentives that would be offered in a Value Page Directory.

FIG. 5 illustrates “banner ads” that would be part of a Value Page Directory that, in this case, advertise generalized inducements, such as offers for free gifts when the consumer participates in some behavior desirable to a merchant.

FIG. 6 illustrates an example of stamped postcards pre-addressed to a merchant tear-out from whom a consumer may indicate in which manner they would like to be contacted by the merchant, such as by telephone, mail, or e-mail

### DEFINITIONS

Coupon, as used herein, is any form of purchasing incentive, such as the ubiquitous paper coupon and may include discount coupons, two-for-one coupons, buy one get one free coupons, rebate offers, bank checks, a free service, a combination thereof, or the like.

Directory, as used herein, refers to a means of providing advisory, but not compulsory guidance or information, such as a list of names of businesses along with contact information for those businesses. A directory may exist in many forms and formats, such as actual or virtual books, booklets, other forms of printed matter, such as magazines, and the like.

Merchant, as used herein, refers to anyone person or any entity whose goal it is to participate in a mutually beneficial transaction, such as a retailer in the process of selling goods or services, and includes merchandisers, wholesaler, and the like.

Merchant Directory, as used herein, refers to a directory that provides a list of names of merchants along with the information a consumer would need to contact each listed merchant. According to the teaching of the present invention, a merchant directory may be referred to as a Value Pages Directory because a Value Pages Directory would also list at least one Value Code for each merchant listed.

Paperless coupon, as used herein, refers to a means for representing or relating to a specific purchase incentive and that serves the same purpose as a paper purchase incentive coupon. Such a means may comprise a code, such as an alpha code, a numeric code, an alphanumeric code, or a code made up of any other symbol or symbols. Herein, such a code is referred to as a Value Code. Value Codes may be presented in a non-electronic form, such as in printed materials, or in an electronic form, such as in virtual printed materials.

Product, as used herein, may comprise both goods and services that are part of a transaction.

Value Code, as used herein, refers to an easy to remember sign that may be a number, a word or set of words, an alphanumeric string, or a symbol and is used to represent a purchase incentive. Value Codes may be presented in a non-electronic form, such as in printed materials, or in an electronic form, such as in virtual printed materials.

Value Incentive, as used herein, refers to any cost savings or other inducements that are presently offered to consumers by merchandisers as a stimulus to consumers to use the products sold by the merchandisers. Cost savings or other inducements may include a reduction in the price of the product, a rebate, two-for-one offers, a chance to be entered into a contest, a gift upon purchase, or a free service, such as two weeks of free snow plowing for the purchase of a given lawn mower.

Mutually benefiting transactors, as used herein, refers to participants in a mutually benefiting transaction, such as when a merchandiser offers a cost-saving incentive for a product desired by a consumer. When the consumer purchases the desired product using the cost-saving incentive offered by the merchandiser both transactors benefit; the merchandiser makes a profit selling the product and the consumer obtains the desired product at a reduced cost.

Objective relationship, as used herein, refers to relationships between entities, including persons, who are participating in a transaction, wherein the relationship has an anticipated outcome.

Reciprocally independent, as used herein, refers to at least two transactors who are participants in a transaction and who are equally independent each from the other, such as a consumer and a merchandiser.

It should be understood that the drawings are not necessarily to scale. In certain instances, details which are not necessary for an understanding of the present invention or which render other details difficult to perceive may have been omitted. It should be understood, of course, that the invention is not limited to the particular embodiments illustrated herein, but encompasses many embodiments as are discussed throughout the specification.

### DETAILED DESCRIPTION

Referring now particularly to the drawings, it should be noted that the disclosed invention is disposed to embodiments in various sizes, shapes, contents, and forms. Therefore, the embodiments described herein are provided with the understanding that the present disclosure is intended as illustrative and is not intended to limit the invention to the embodiments described herein.

In general, the invention teaches a means for merchants to present paperless purchase incentives to consumers, where one example of the means is a merchant directory, comprising:

a) merchant contact information, and

b) Value Codes representing purchase incentives that are redeemable at the time that a precondition is met, such as when the consumer purchases the merchant's product. Of course, the precondition is not limited to a product purchase, but could include simply visiting the store, putting an intended purchase on layaway, or simply trying an example of the product, whether the product is a goods or service. A Value Code may be presented with specific particulars, such as exactly what the purchase incentive is and what the consumer must do to redeem the incentive. On the other hand, the Value Code may not include particulars, whereby an interested consumer would have to contact the merchant to find out the particulars of each incentive. Directories, or other means, may be distributed as printed matter or in electronic form and may include free gift offers to promote consumer loyalty to the directory. Additionally, the directory includes a system, such as preaddressed, stamped postcards, for consumers to supply their contact information to merchants so that merchants may contact these consumers who have demonstrated their predisposition to know more about merchant's products. The postcards, or other systems, may also include Value Codes as an inducement to consumers to provide merchants with consumer contact information. Directory listings may be limited to a maximum number of advertisers and may be arranged by seniority, where the first to list in the directory is the most senior, and, thus, will be the first merchant listed in the section of the directory that list merchants in a particular category. The purchase incentives that are represented by Value Codes may be discount offers, two-for-one offers, buy one get one free, rebates, bank checks, a combination thereof, a free service, or the like.

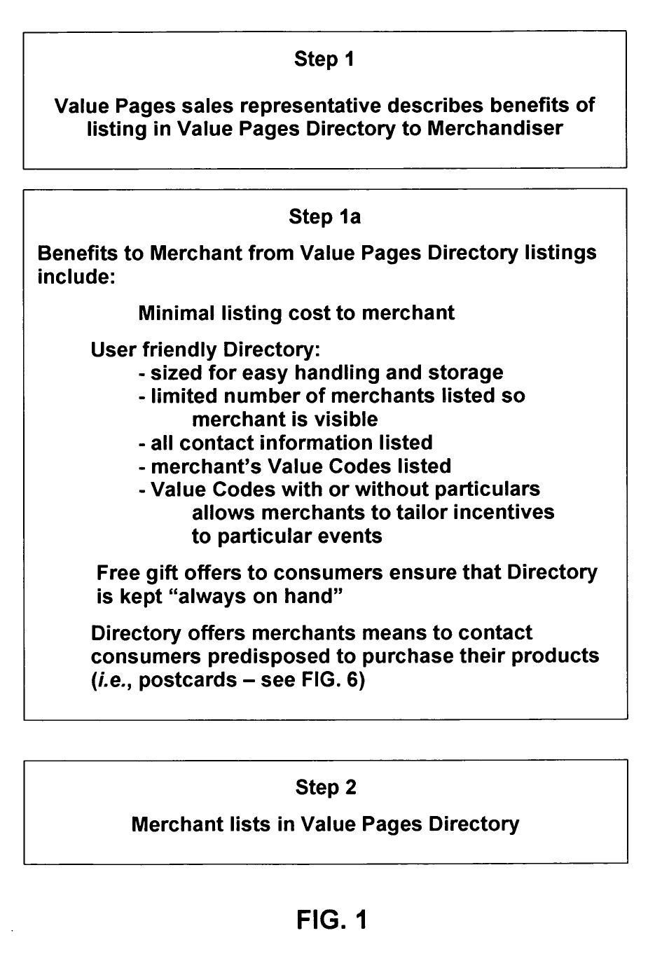

FIG. 1 illustrates, using a step-chart, a preferred embodiment of a method for creating objective transactional relationships between reciprocally mutually benefiting transactors, wherein transactors constitute at least one merchant and at least one consumer, said method comprising the steps of:

a) providing for at least one Value Code wherein at least one Value Code represents at least one product purchase incentive offered by at least one merchant to at least one consumer;

b) providing a means for distributing at least one Value Code to at least one consumer, where the means may be a merchant directory that may be referred to as a Value Pages Directory, and

c) distributing said at least one Value Code to said at least one consumer using said means for distributing, wherein said product purchase incentive is redeemed at product purchase.

As can be seen from FIG. 1, the Step 1 of the method may be for a Value Pages Directory sales representative to explain to a merchant the benefits of being listed in a Value Pages Directory. As Step 1a illustrates, one of the many benefits of the directory is that listing in a Value Pages Merchant Directory is affordable, even to small and new business, especially when the cost of a Value Pages listing is compared to the cost of other forms of advertising, such as placing an advertisement in a newspaper, magazine, television, or radio. Moreover, when it is desired to have a directory in printed matter form, the directory is sized for easy handling, that is, the directory is not too heavy or too large to be easily and conveniently stored and used. Another benefit is that it is contemplated that the number of merchants permitted to list in the directory be limited. Limiting the number of listings also makes the directory easier to use as it eliminates the confusion and frustration felt by consumers when presented with an unwieldy number of choices among merchants. Limiting the number of merchants accepted for listing also limits competition between or among merchants who would all be seeking the patronage of a select group of consumers. A merchant directory, according to the principles of the present invention, lists all of a merchant's contact information, including address of place of business, telephone number(s), facsimile number(s), e-mail address, and web-site address, making it easy for a consumer to contact a merchant. In addition to listing all of the merchant's contact information, the merchant directory presents consumers with a merchant's Value Code or Codes, where each Value Code stood for a purchase incentive offer. It is important to note, that the purchase incentive offer is being presented to the consumer at exactly the time that the consumer is ready to make a purchase. Thus, the inventive offer, represented by the Value Code, is reaching a select, predisposed set of consumers. In some cases, a merchant may choose to describe the incentive offer; however, in other cases a merchant might simply list a Value Code. In this case, a consumer would contact the merchant for details regarding the offer. The contact could be in the form of a telephone call, a facsimile communication, an e-mail, or a visit to the store. A merchant who prefers changing the purchase incentive at frequent intervals, might choose listing a Value Code without particulars.

When a consumer is ready to make a purchase, the consumer will note the Value Code. The consumer may do this by simply remembering the Value Code, by noting the code on a piece of paper, or by taking the Value Pages Directory along to the merchant's place of business. Some merchants may even accept the consumer's statement that he or she obtained merchant's contact information and saw the Value Code, along with its particulars if the particulars are listed, in lieu of the Code itself. Having a purchase incentive represented by a Value Code becomes especially important when a consumer wishes to make a purchase over the telephone or electronically, where in both cases it would be impossible for a consumer to present a paper coupon.

In addition to listing a merchant's contact information and desired Value Codes, the merchant directory may also include any desired number of merchant's free gift offers. Listing free gift offers provides several advantages. One advantage is that the offer can be an inducement to consumers to make repeat visits to the merchant's place of business. For example, a merchant offers one free gift a month/per consumer/per visit to merchant's place of business. Another advantage to the merchant is that the free gift reward value offered by the directory keeps consumers loyal to using the directory. Consumers benefit also, as they are presented with free gift offers, sometimes by many merchants.

Another benefit received by merchants when they list in a merchant directory of the present invention, is that the directory offers each merchant a means to directly contact consumers who are predisposed to the purchasing the merchant's product. One way of accomplishing this is for a merchant, through the directory, to present consumers with the opportunity of presenting their contact information to the merchant. For example, a merchant may provide each directory with one or more stamped self-addressed postcards. On the back of each postcard there is a place for a consumer to list how they would like to be contacted by merchant and their relevant contact address. If desired, merchant could provide each postcard with a Value Code that could be redeemed for a purchase incentive or free gift that would be contingent upon the consumer meeting a defined condition, such as delivering the filled-in postcard to the merchant's place of business.

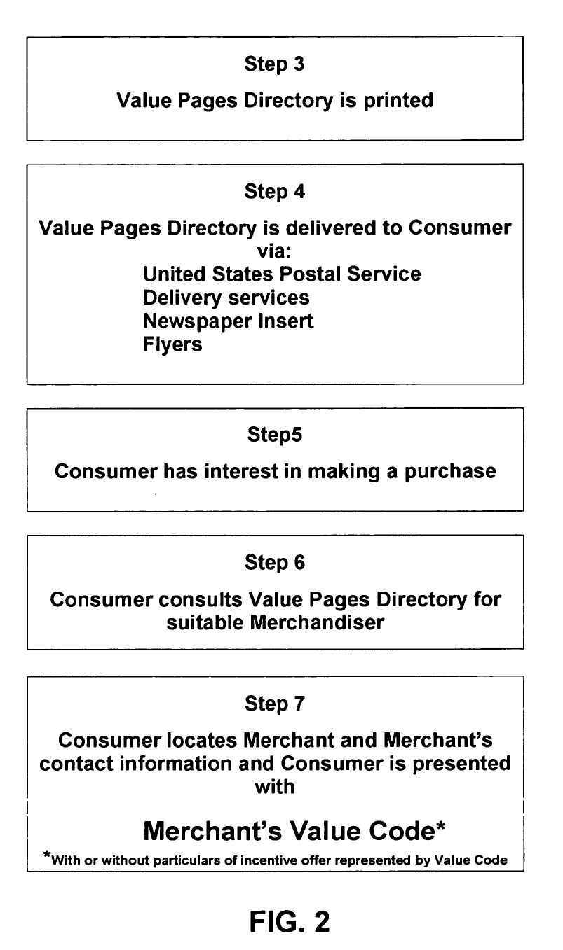

Once a set of merchants agree to be listed in a merchant directory, as is shown in Step 2, the directory is printed and made available to consumers (see Steps 3 and 4 in FIG. 2). Step 4 lists some examples of ways that the directory may be delivered to consumers. One way is for the directory to be delivered directly to the consumer's home. To make sure that the directory is available to all consumers, copies of the directory could be made available where other free publications are made available, such as in the entrances of supermarkets. Whenever a consumer is thinking seriously about making a purchase, as is indicated in Step 5, the consumer consults a Value Pages merchant directory to identify which merchants carry the product (Step 6) that the consumer is interested in and how the merchant can be contacted, and at this exact time, the consumer is presented with merchant's purchase incentive. If the merchant has listed particulars of the purchase incentive, the consumer knows immediately what cost-savings will occur upon purchase. If the merchant chooses not to list particulars of the purchase inventive offered, the consumer can easily contact the merchant to inquire into the details of the offer (Step 7).

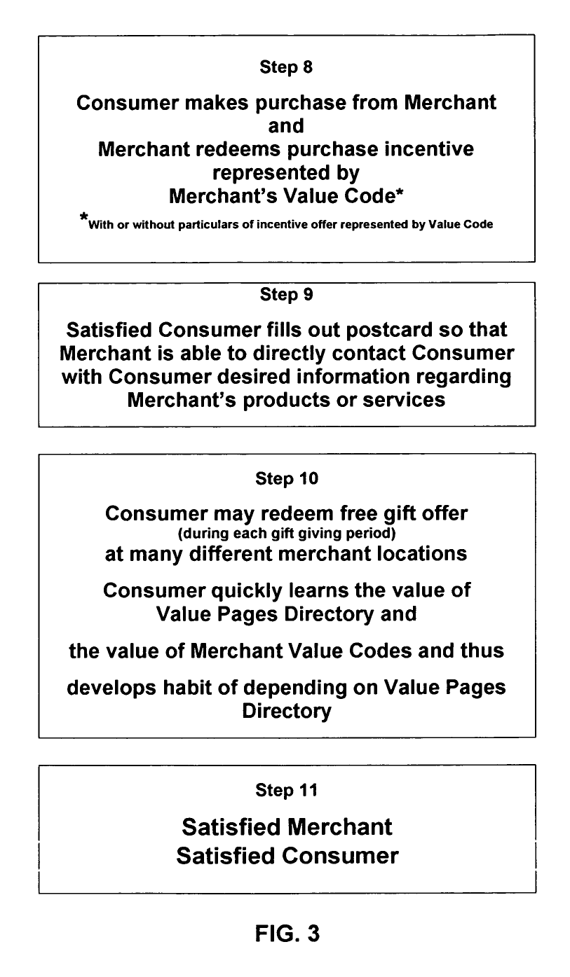

FIG. 3 is another step-chart diagram continuing to illustrate exemplary procedural steps of the paperless coupon/Value Code advertising method, as illustrated in FIGS. 1 and 2. After a consumer locates a merchant of interest in the merchant directory of this invention, the consumer makes a note of the merchant's Value Code, and visits, literally or virtually, the merchant's place of business to make the desired purchase (see Step 8). At the time of purchase, the purchase incentive, represented in the Value Pages Directory by a Value Code, is redeemed as is stated in Step 8.

Step 9 indicates how the directory also offers each merchant means to identify consumers predisposed to purchasing merchant's goods or services, or both. In one preferred embodiment, the means to do this comprises a postcard that is attached to Value Pages Directory, where the postcard is stamped and addressed to a merchant who decides to participate in this method for obtaining consumer contact information. On the back side of the postcard there is space for a consumer, who is interested in being contacted by merchant, to place the address of his or her preferred way of being contacted. Merchants may decide to include at least one Value Code on the postcard as an added inducement for consumer to provide merchant with his or her contact information. Offering a purchase incentive represented by a Value Code on a postcard could also be a way to entice consumer into bringing the filled in postcard directly to merchant's place of business. Consumer also benefits, as consumer will now be directly notified of upcoming sales or other information of interest to consumer.

Step 10 presents the value of combining free gift offers with a Value Pages Merchant Directory. If a merchant offers one free gift a month per consumer, such as a free doughnut from a bakery or a free toothbrush from a pharmacy, for example, consumers are very likely to keep the directory stored in a place that makes the directory as easy to find as it is to use. Most consumers enjoy getting a free gift and merchants benefit because it is likely that when visiting merchant's place of business, consumer will make a purchase.

Step 11 provides a most important benefit derived from using the Value Page Directory along with its Value Codes—satisfied consumers and satisfied merchants.

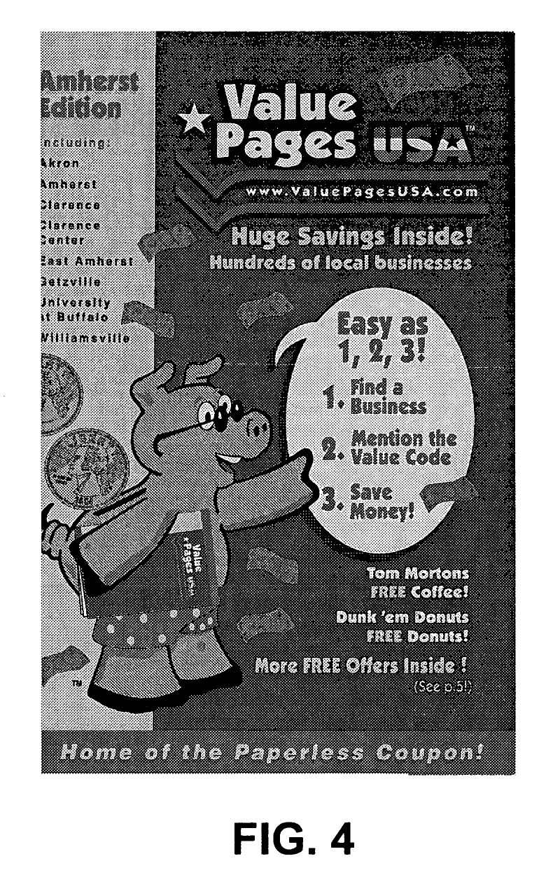

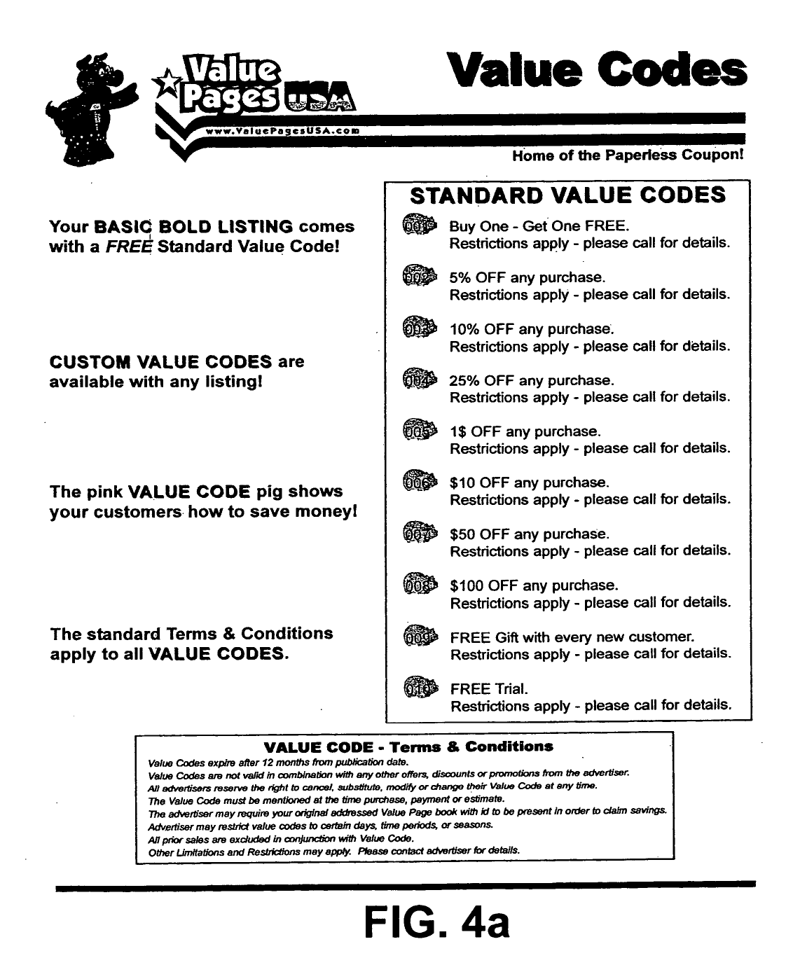

FIG. 4 illustrates an exemplary cover page of an exemplary Value Page Directory containing Value Codes (see FIG. 4a. for some examples of the kinds of purchase incentives can be represented by the Value Codes that are each printed on a piggy savings bank). The text on the cover reiterates what has been discussed above, that the invention provides cost savings for both merchants and consumers, that using the Value Pages directory is easy, and that free gift offers benefit both merchants and consumers.

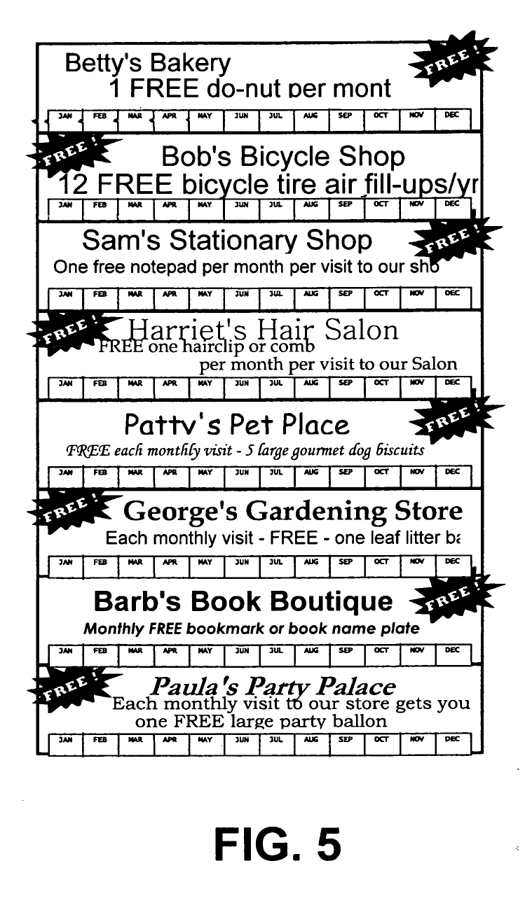

Free gift offers may be presented in a Value Page Directory as banner advertisements, as is illustrated in FIG. 5. In this example, generalized inducements, such as offers for free gifts from a variety of merchant are presented. The free gift is earned by consumer when the consumer participates in some behavior defined by and desirable to a merchant, such as making a visit to merchant's shop.

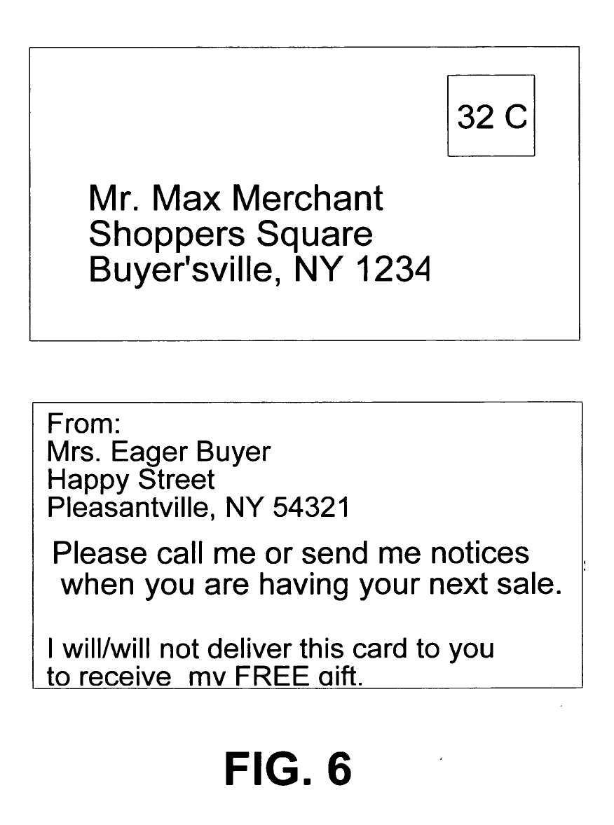

FIG. 6 illustrates an example of one of the means of the invention that merchant can use to identify consumers predisposed to purchasing merchant's goods or services, or both. In this embodiment, the means comprises a postcard that is detachably attached to a Value Pages Directory. Postage is supplied by the merchant and the card is pre-addressed to the merchant. Consumer may use the postcard to indicate in which manner they would like to be contacted by a merchant who handles a good or service of interest to a consumer. Consumer would also provide merchant with an address by which consumer may be contacted. Consumer could indicate which kind of information he or she is interested in receiving. Consumer could also take advantage of any purchase incentive or free gift off merchant may choose to place on a postcard. A purchase incentive or the offer of a free gift is a powerful incentive for consumer to fill in the postcard for merchant's use.

Thus, it will be appreciated that the method and means for creating objective relationships between reciprocally independent and mutually benefiting transactors comprising a merchant directory, such as a Value Pages Merchant Directory along with the listing of Value Codes that represent purchase incentives will easily, quickly, reliably connect consumers having specific interests to merchants having the goods or services of interest to consumers. It has been shown that the system provides for the creation of mutually beneficial relationships between consumers and merchandisers without compromising a consumer's privacy. Also provided for is means for consumers to obtain a cost saving incentive at exactly the time it is most useful to consumer and to merchant. This direct marketing also results in great advertising savings for merchandisers, as well as cost benefits for consumers. Purchase incentives, represented by Value Codes, for selected goods or services will be presented only to those persons having a predetermined interest in receiving the incentive, which means that there is a great likelihood of those purchase incentives being redeemed, which of course means that the merchandiser's products have a greater likelihood of being purchased.

The foregoing description, for purposes of explanation, usesspecific and defined nomenclature to provide a thorough understanding of the invention. However, it will be apparent to one skilled in the art that the specific details are not required in order to practice the invention. Thus, the foregoing descriptions of specific embodiments are presented for purposes of illustration and description. They are not intended to be exhaustive or to limit the invention to the precise forms disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. Means for a merchant to present paperless purchase incentives to at least one consumer, said means comprising:
a) contact information relating to at least one merchant, and
b) at least one Value Code, wherein said at least one Value Code represents at least one purchase incentive for the purchase of the merchant's products, wherein said value incentives are redeemable at product purchase.

2. The means, as recited in claim 1, further comprising including a process by which said means are made available to said at least one consumer.

3. The means, as recited in claim 1, further comprising wherein said means is printed matter.

4. The means, as recited in claim 1, further comprising wherein said means comprises electronic means.

5. The means, as recited in claim 3, wherein said electronic means further comprises an interactive Internet site.

6. The means, as recited in claim 1, wherein said means further includes at least one free gift offer.

7. The means, as recited in claim 1, further comprising wherein said means includes a system for at least one merchant to contact consumers predisposed to purchase the merchant's products.

8. The means, as recited in claim 7, wherein said system further comprises at least one stamped postcard pre-addressed to at least one participating merchant,
wherein said postcard may include said at least one Value Code, and
wherein consumer contact information may be provided to the merchant.

9. A method for creating objective transactional relationships between reciprocally mutually benefiting transactors, wherein transactors are at least one merchandiser and at least one consumer, said method comprising the steps of:
a) providing for at least one Value Code wherein said at least one Value Code represents at least one product purchase incentive offered by at least one merchant to at least one consumer;
b) providing a means for distributing said at least one Value Code to said at least one consumer, and
c) distributing said at least one Value Code to said at least one consumer using said means for distributing, wherein said product purchase incentive is redeemed at product purchase.

10. The method, as recited in claim 9, further comprising wherein each of said Value Codes comprises an alpha code, a numeric code, an alphanumeric code, or a code of other symbols.

11. The method, as recited in claim 9, further comprising wherein said product purchase incentive is a discount offer, two-for-one offer, buy one get one free offer, a rebate offer, a bank checks, a combination thereof, or the like.

12. The method, as recited in claim 9, further comprising wherein said product purchase incentive is a free service.

13. The method, as recited in claim 9, further comprising wherein said means for distributing said at least one Value Code is a directory.

14. The method, as recited in claim 13, wherein said directory further comprises printed material.

15. The method, as recited in claim 13, wherein said directory further comprises an electronic directory.

16. The method, as recited in claim 15, wherein said electronic directory is available to said consumers via an interactive computer system.

17. The method, as recited in claim 16, wherein said interactive computer system is part of the World Wide Web.

18. The method, as recited in claim 9, wherein said means for delivering said paperless coupons to at least one consumer, further comprises directory listings arranged by seniority.

19. The method, as recited in claim 9, wherein said listings are limited to a maximum number of advertisers.

20. A paperless-coupon merchant directory in which at least one merchant presents at least one paperless purchase incentive to at least one consumer, said directory comprising:
a) contact information relating to said at least one merchant, and
b) at least one Value Code representing said at least one purchase incentive, wherein said purchase incentive is redeemable at time of product purchase,
wherein said directory may comprise printed matter or be an electronic directory on a computer network such as the Internet.
